(19) United States
(12) Patent Application Publication
(10) Pub. No.: US 2022/0046944 A1
(43) Pub. Date: Feb. 17, 2022

(54) MOLD FOR VEGETABLE FATS AND USE OF SAME

(71) Applicant: Guy VAN CRUCHTEN, Wemmel (BE)

(72) Inventor: Guy VAN CRUCHTEN, Wemmel (BE)

(21) Appl. No.: 17/415,697

(22) PCT Filed: Jan. 3, 2020
(86) PCT No.: PCT/EP2020/050065

§ 371 Date: Jun. 17, 2021

(30) Foreign Application Priority Data
Jan. 3, 2019 (BE) 2019/5002

(51) Int. Cl. A23G 1/50; A23G 1/00; A23G 1/22; A23G 1/32

(52) U.S. Cl. CPC A23G 1/50; A23G 1/0063; A23G 1/0086; A23G 1/226; A23V 2002/00; A23V 2200/044; A23V 2250/18; A23G 2200/08; A23G 1/32

(57) ABSTRACT

A mold to receive liquid chocolate consists of two elements, a front element representing a three-dimensional shape where are present variations in height that are associated with a predefined pattern with a flat base and a rear element including a continuous mesh whose surface covers exactly the flat surface of the front element, said mesh delimiting cells, each cell including a hole, the surface of the rear element being delineated for its arrangement with the edge of the front element, the mesh being configured to print molded chocolate streaks, the base of the mesh of the rear element forming a plan.

### TECHNICAL FIELD OF THE INVENTION

This invention relates to chocolate, or to other solid vegetable fats at room temperature, representing a filled three-dimensional shape and separable into portions intended to be ingested.

### TECHNOLOGICAL BACKGROUND OF THE INVENTION

This patent application is in the field of food, especially chocolate. Chocolate is marketed as a tablet, which usually follows the shape of a filled parallelepiped. The advantage associated with making in the form of tablets lies in the ease of molding, where the melted chocolate is applied in an open mold and then scraped. This packaging allows the consumer to easily split the mass of chocolate into small unmanageable units. In particular, the shelves are fractionnable according to streaks whose size and geometry were imposed by the shape of the mold.

Various publications describe chocolate products or molds, but do not include all the characteristics that allow this invention.

In particular, WO 2015/101964 describes a method of preparing a chocolate, but the shape is not three-dimensional (the rear mold is flat), and the front mold does not have beveled holes or edges.

WO 2015/019252 describes a concave edible product, but lacking a mesh of streaks.

GB 2219724 describes a chocolate without streak mesh.

U.S. Pat. No. 1,908,323 describes an ice mold that does not define a three-dimensional structure, beveled orifices or ends at the front mold.

FR 2660161 describes a chocolate bar without 3D shapes.

WO 84/01269 describes a product printed with a figure. It is not a three-dimensional shape.

GB 525318 describes a mechanism for emptying molds, not a three-dimensional shape.

EP 2468108 describes a piece of chocolate with a flat base on which different objects are associated. It is therefore not a piece of chocolate with a three-dimensional shape.

### SUMMARY DESCRIPTION OF THE INVENTION

This invention differs from prior art in that the melted chocolate is placed in the front element of a mold (1) until it is filled (substantially), the front element of this mold (1) representing a three-dimensional shape where variations in height are present that are associated with a predefined pattern (2). The rear element (3) of the mold also includes a continuous mesh (4), or semi-continuous, having a given width (11) and height (10), which will print streaks to the molded chocolate, allowing its break for ingestion; the density of the mesh (4), thus the surface, and/or volume, of the mesh being defined so that each cell (5), once separated can be easily ingested.

A first aspect of this invention is therefore a mold to receive liquid chocolate (or a liquid icing paste or any other dietary composition based on liquid vegetable fats at a temperature above 25 degrees Celsius (preferably >30 degrees Celsius, or even >40 degrees Celsius) and solid at room temperature) and consisting of two elements, a front element (1) representing a three-dimensional shape where height variations are present that are associated with a predefined pattern (2) with a flat base and a rear element (3) comprising a continuous mesh (4) whose surface covers exactly the flat surface of the front element (1), this mesh (grid) delimiting cells (5), each cell (5) including a hole (8), the surface of the rear element (3) being delineated for an arrangement with the edge of the front element, the mesh (4) being to print molded chocolate streaks (in the front element (1)), the base of the mesh of the back element forming a plan (9).

Advantageously, the hole (8) fills the entire cell (5).

According to an alternative, the mesh (4) do not contain a hole and are beveled (7) (cf. below).

Advantageously, the streaks are for an easy splitting of the molded chocolate into units in order to be easily ingested by a human.

Preferably, the mesh (4) are beveled (7) (rounded) at their distant end of (forming a protrusion from) the base (9); i.e. the end of the mesh (4) protruding from the base (9) of the rear element (3) is beveled (rounded) (7).

Advantageously, the height (10) and/or width (11) of the mesh (4) is substantially constant.

Preferably, the edges (6) that form the edge of the front element (1) of the mold are beveled.

Advantageously, the front element (1) and/or the rear element (3) is thermoformable plastic, for example in PET or PVC, polycarbonate, acrylic or resin.

Preferably, the front element (1) is a structure with a thickness of between (about) 20 μm and (about) 2000 μm.

A related aspect of this invention is a process for the manufacture of a vegetable fat-based food composition (a chocolate or an icing paste) with a three-dimensional shape in which height variations are present that are associated with a predefined pattern (2) including the following successive steps:
taking the front element (1) of the mold described above, having the desired three-dimensional shape;
filling the front element (1) of the said mold with the vegetable fat-based food composition (melted chocolate or melted icing paste);
applying the back element (3) of the mold (described above) when the food composition based on vegetable fats (chocolate or icing paste) poured into the front element (1) of the mold is still liquid and for a sufficient time for the vegetable fat-based food composition (chocolate or icing paste) to be solidified, so as to print the grooves;
removing the rear element (3) from the mold.

Advantageously, the vegetable fat-based food composition (chocolate or icing paste) is poured into several front elements (1) of the mold before the rear element (3) of the mold is applied successively to the front elements (1) of filled molds.

For the above process, the vegetable fat-based composition includes at least 5% (preferably at least 10%, at least 15%, or even at least 20%) in dry weight of vegetable fats and has a melting point between 25 and 60 degrees Celsius, preferably between 30 and 50 degrees Celsius, or even between (about) 35 degrees Celsius and (about) 40 degrees Celsius.

For the above process, the dietary composition based on vegetable fat is advantageously chocolate, i.e. any dietary fat qualified as such, for example whose melting point is between 25 and 60 degrees Celsius, preferably about 37 degrees Celsius (e.g. between 35 and 40 degrees Celsius). Chocolate is chosen for example from dark chocolate, white chocolate, milk chocolate, pink or blond chocolate and the mixtures between them, as well as mixtures between dark chocolate, white chocolate, milk chocolate, pink chocolate or blond chocolate and vegetable fats, but may also include chocolate described above that would be colored differently, due to the presence of an additional pigment.

The term “chocolate” in this invention may also mean vegetable fats marketed as a chocolate substitute (for example, under the name “compound”), but without cocoa.

Preferably, the mixtures between dark chocolate, white chocolate, milk chocolate, pink chocolate, blond chocolate and vegetable fats result in a material with the same fusion profile as black chocolate, white chocolate, milk chocolate, pink chocolate or blond chocolate alone. The crystallization forms of the above mixes may be similar to that of pure chocolate, but may also differ, especially when vegetable fats from sources other than cocoa are used.

Alternatively, the vegetable fat-based food composition of this invention is advantageously an icing paste. In the context of this invention, it is solid at room temperature (or even at 30 degrees Celsius or 35 degrees Celsius), but is liquid at temperatures between 40 and 60 degrees Celsius (or even higher). Preferably, the ice sheet in this invention is (includes, consists (essentially) of) a mixture of vegetable fats and milk or cocoa. The ice sheet in this invention may include other dietary compounds, such as sugars as long as vegetable fats, milk or cocoa (if present) account for at least 5% (at least 10%, at least 20%, or even at least 30%) in dry weight of the composition.

An associated aspect of this invention is a dietary composition based on vegetable fat (a mass of chocolate or icing paste paste) that can be obtained by the process described above.

In particular, a mass of chocolate or an icing paste with a base forming a plane and a three-dimensional shape where variations in height are present that are associated with a predefined pattern, in which the base forming a plane includes a mesh of streaks delimiting cells.

Preferably, the cells of this mass of chocolate (or icing paste paste) represent a volume that can be ingested by a human (child or adult).

Preferably, the mesh of streaks of this mass of chocolate (or this icing paste) consists of segments organized in two dimensions, the segments of each dimension being advantageously parallel with each other.

The chocolate that makes up this mass of chocolate is as described above, and is for example any dietary fat qualified as such, for example whose melting point is between 35 and 40 degrees Celsius, preferably about 37 degrees Celsius. Preferably, chocolate is chosen from dark chocolate, white chocolate, milk chocolate, pink chocolate and blond chocolate and the mixtures between them, as well as blends between dark chocolate, white chocolate, milk chocolate, pink chocolate, blond chocolate and vegetable fats. The chocolate in this invention may also include chocolate described above that would be coloured differently, due to the presence of an additional pigment. The term “chocolate” in this invention may also mean vegetable fats marketed as a substitute for chocolate (for example, under the name “compound”), but without cocoa. In the context of this invention, these vegetable fats have a melting point generally between (about) 25 and (about) 60 degree Celsius, preferably between 35 and 40 degrees Celsius.

Preferably, the mixtures between dark chocolate, white chocolate, milk chocolate, pink chocolate and blond chocolate and vegetable fats result in a material with the same fusion profile as black chocolate, white chocolate, milk chocolate, pink chocolate or blond chocolate alone, and/or is crystallized in the same form.

Advantageously, one or more patterns of the three-dimensional shape are (are) colored, i.e. edible pigments (compatible with human food) have been locally added to the surface of one or more patterns of the three-dimensional shape.

### BRIEF DESCRIPTION OF THE DRAWINGS

FIG. 1 is a front view of the front element (1) of the mold and view of the rear element (3) of the mold.

FIG. 2 is a schematic view of the back (3) of the mold showing a sagittal cross section (seen facing its small side) of a mesh, and its beveled end (7).

### DETAILED DESCRIPTION OF THE INVENTION

The inventor managed to combine the practicality of a chocolate bar with the aesthetics of chocolate with a three-dimensional shape where variations in height are present that are associated with a predefined pattern.

In addition to chocolate, the invention applies to any solid food composition at room temperature and to which one would like to give a three-dimensional shape where variations in height are present that are associated with a predefined pattern, while allowing its splitting into units that can be ingested.

An example of such food compositions is icing paste or sugar paste.

This invention is based on a mold consisting of two elements (1) and (3), the front element (1) representing a three-dimensional shape having a flat (not shown) base, this three-dimensional shape is intended to be filled with melted chocolate and whose height variations are associated with a predefined pattern (2) and the rear element (3) comprising a mesh grid (4) (also mentioned as grid or simply meshes; 4) whose surface covers exactly the flat surface of the front element, and forms separate cells (5), each cell (5) comprising at least one orifice (8), the base of the mesh of the rear element (3) forming a plane (9).

The orifices (8) are intended to let the air come out when the two elements (1) and (3) of the mold are arranged, so as to close the mold without causing heterogeneity to the mass of melted chocolate present there. The size of the orifices (8) can vary, from a simple orifice (8) whose surface is insignificant in relation to the surface of the cell (5), for example 5% of the surface or more, such as 10% of the surface or more, or even 20%, 30%, 75% or more, until filling the entire cell (5); in this case, the rear element of the mold is just a mesh (the mesh grid; 4; the mesh; 4). This is advantageous for the manufacture of the rear element (3) of the mold, and for its application to the front element (1).

The mesh (4) of the rear element of the mold (3) has a height (10) chosen to allow the molded chocolate to be easily split into units that can be ingested.

Similarly, the width of the mesh (11) is chosen for the same purpose.

The rear element (3) of the mold, even if it is a simple mesh, can however include an external surface to the mesh that is full, and preferably flat.

This allows for a better arrangement of the rear element (3) of the mold with the back side of the front element (1) of the mold, especially if the front element (1) of the mold also includes a flat surface surrounding the three-dimensional pattern, for example these two flat surfaces of the front elements (1) and rear (3) having substantially the same surface, and thus ensures a good control of the insertion of the protrusion formed by the mesh (4) of the rear element (3) of the mold in the cavity formed by the front element of the mold, i.e. the grooves of the chocolate, once it solidified.

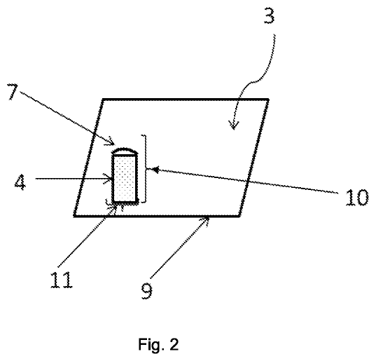

Advantageously, the meshes (4) are (slightly) beveled (7) at the end. Thus, the end of the mesh may have, for example, the shape of a half-sphere (as shown in FIG. 2), or a trapezoidal shape.

This allows a simplified insertion of the rear element (3) of the mold into the mass of chocolate (or icing paste) poured into the front element (1), and a easier removal of the rear element (3) of the mold, once the chocolate (or icing paste) has been solidified.

The meshes (4) do not necessarily have a constant height (10), although a substantially constant height (10) (e.g. a proportion between the deepest and the shallowest of less than 2 to 1, preferably less than 1.5 to 1) is preferred. Similarly, meshes (4) does not necessarily have a constant width (11), although a substantially constant width (11) (e.g. a proportion between the widest mesh and the smaller mesh of less than 2 to 1, preferably less than 1.5 to 1) is preferred.

The height of the mesh (10) is, advantageously, determined according to the height of the front element (1) of the mold to allow portions to be broken easily. The mesh (4) is, advantageously, formed from a plurality of segments (12), spread over the surface of the rear element (3) of the mold and thus form a two-dimensional network. The meshes (4) of each dimension are advantageously parallel to each other, at least on a substantial part of the rear element. The two dimensions of the segments (12) can be perpendicular to each other, which is advantageous for the manufacturing, aesthetics and to allow the surface of the cells (5) to be constant.

The edges (6) that form the perimeter of the front element (1) of the mold are, advantageously, beveled (or chamfered). This prevents too much chocolate from accumulating in this area.

The elements (1) and/or (3) of the mold can be made of plastic, preferably in thermoformable plastic, for example in PET, PVC or resin. Elements (1) and/or (3) made of polycarbonate or acrylic represent an alternative, useful for larger-scale chocolate production.

The thickness of the structure forming the front element (1) of the mold (especially when it is made of thermoformable plastic) is advantageously between 20 μm and 2000 μm, preferably between 200 and 600 μm.

A related aspect of this invention is a method for making a chocolate or icing paste with a three-dimensional shape (2) where variations in height are present that are associated with a predefined pattern including the following successive steps:
taking the front element (1) of the mold defined above, having the desired three-dimensional shape;
filling the front element (1) of the mold with melted chocolate or melted icing paste batter;
applying the back element (3) of the mold when the chocolate or ice sheet cast in the front of the mold is still liquid and for a sufficient time for the chocolate or icing paste to be solidified, so as to print grooves due to the insertion of the meshes (4) having a given height (10) and width (11) in the mass of chocolate or melted icing paste;
removing the back element (3) from the mold when the chocolate or icing paste has been solidified.

Advantageously, the chocolate (or icing paste) is poured into several front elements (1) of the mold before the same back element (3) of the mold is applied successively to the front element (1) filled, the chocolate (or icing paste) being still liquid.

Chocolate can be dark chocolate, milk chocolate, white chocolate, pink chocolate or blond chocolate, or chocolate (dark) mixed with milk, or even vegetable (or animal) fats. Preferably, its taste, its physical properties (melting profile and/or type of crystals) and/or its name is compliant with that of dark, white or milk chocolate.

Chocolate may include additional pigments (compatible with food use). Similarly, the chocolate of this invention can be a fat (vegetable, except for the milk possibly present) with a fusion profile substantially similar to that of chocolate (e.g. between 25 and 60 degrees Celsius, preferably between 35 and 40 degrees Celsius), but not from cocoa. Among these are chocolate substitutes sold under the name “compound.”

In reference to the figures, the invention is based on a mold in two elements (1) and (3). The front element (1) is the front of the mold; here the shape is one of a panda. Of course, any three-dimensional form where height variations are present that are associated with a predefined pattern (2) are covered by this invention. Possible forms include animals, known and/or appreciated people or monuments, particular objects, or even miniatures of planes or boats: the invention deals with shapes with a three-dimensional shape and a face printed by a mesh.

The base of the front element (1) of the mold is open and is substantially flat. Thus, this mold offers a certain empty volume, intended to be filled, substantially completely, with liquid chocolate.

Then the back element (3) of the mold is applied to the mass of liquid chocolate.

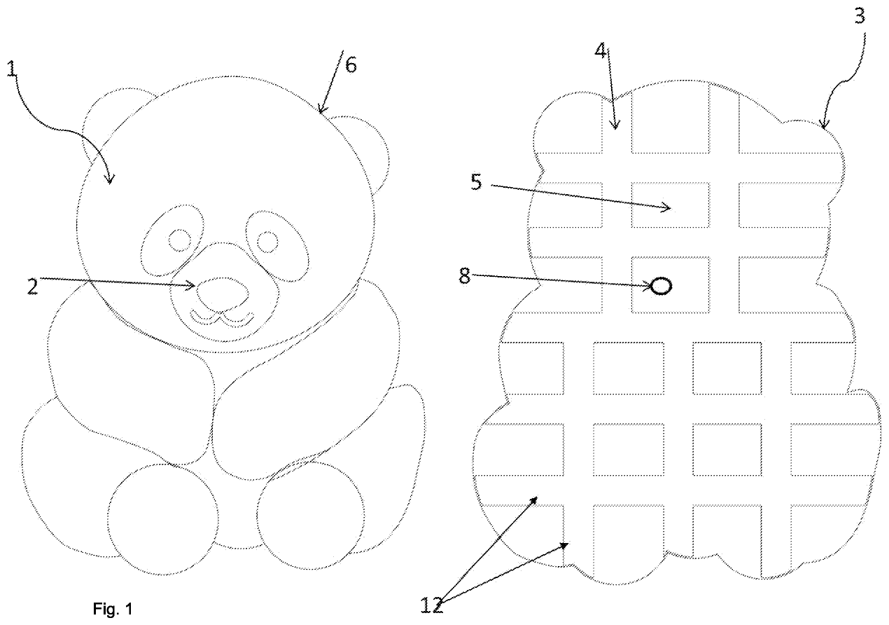

Given the presence of the meshes (4), this will print a pattern on the back of the chocolate mass. In particular the pattern can be a checkerboard made up of quadrangles, in the case shown in FIG. 1, rectangles. In other words, the segments (12) that form the mesh (4) are arranged in two dimensions, and for each dimension are parallel.

Depending on the geometry of the three-dimensional shape, the segments (12) that form the mesh (4) may not be a continuous line over the entire dimension (width or length) of the rear element (3) of the mold, as shown in FIG. 1, where the segments (12) that form the length of the rear element (3) of the mold are discontinuous.

The chocolate obtained has a three-dimensional shape, here, a panda, and is full of chocolate. However, this full object can be easily broken down into portions that can be ingested.

The different (three-dimensional) patterns can be printed in colour consistent with food and food additive regulations, further increasing the appeal of the invention.

1. A mold for receiving liquid chocolate, comprising:
a front element representing a three-dimensional shape wherein variations in height that are associated with a predefined pattern with a flat base are present; and
a rear element including a mesh whose surface covers exactly the planar surface of the front element, the mesh delimiting cells, each cell including a hole, the surface of the rear element being delimited for its arrangement with the flat base of the front element, the mesh being arranged for printing streaks onto the molded chocolate and the base of the mesh of the rear element forming a plane.

2. The mold according to claim 1, wherein the hole is intended to let the air exit when the two elements and of the mold are arranged.

3. The mold according to claim 1, wherein the hole fills the entire cell.

4. The mold according to claim 1, wherein the mesh is beveled, preferably rounded, at a far end of the base.

5. The mold according to claim 1, wherein the height and/or width of the mesh is substantially constant.

6. The mold according to claim 1, wherein an edge of the front element of the mold is beveled.

7. The mold according to claim 1, wherein the front element and/or the rear element is thermoformable plastic, for example in PET or PVC, polycarbonate, acrylic or resin.

8. The mold according to claim 1, wherein the front element is a structure with a thickness of between 20 μm and 2000 μm, preferably between 200 and 600 μm.

9. A process for making a three-dimensional chocolate or icing paste, wherein height variations associated with a predefined pattern are present, the method comprising the following successive steps:
taking the front element of the mold of claim, having the desired three-dimensional shape;
filling the said front element of the mold with melted chocolate or melted icing paste;
applying the rear element of the mold when the chocolate or ice sheet poured into the front element of the mold is still liquid and during a sufficient time for the chocolate or icing paste to be solidified, so as to print the grooves; and
removing the rear element from the mold.

10. The process according to claim 9, wherein the chocolate or icing paste is poured into several front elements of the mold before the rear element of the mold is applied successively to the filled front elements.

11. The process according to claim 9, wherein the chocolate is chosen from dark chocolate, white chocolate, milk chocolate, pink chocolate, blond chocolate and mixtures therebetween, as well as mixtures between dark chocolate, white chocolate, milk chocolate and vegetable fats and/or food pigments.

12. The process according to claim 11, wherein the mixtures between dark chocolate, white chocolate, milk chocolate, pink chocolate, blond chocolate and vegetable fats are a material having the same fusion profile as said dark chocolate, said white chocolate, said milk chocolate, said pink chocolate, or said blond chocolate alone, and/or being crystallized in the same form.

13. A piece of chocolate or icing paste having a base forming a plane and a three-dimensional shape where variations in height are present that are associated with a predefined pattern, in which the base forming a plane includes a mesh of streaks delimiting cells

14. The piece of chocolate or icing paste according to claim 13, wherein cells represent a volume that can be ingested by a human.

15. The piece of chocolate or icing paste according to claim 13, wherein the mesh of streaks is made up of segments organized according to two dimensions, the segments of each dimension being parallel with each other.

16. The piece of chocolate or icing paste according to claim 13, wherein said chocolate is chosen from dark chocolate, white chocolate, milk chocolate, pink chocolate and blond chocolate and the mixtures therebetween, as well as mixtures between dark chocolate, white chocolate, milk chocolate, pink chocolate, blond chocolate and vegetable fats and/or food pigments.

17. The piece of chocolate or icing paste according to claim 16, wherein the mixtures between dark chocolate, white chocolate, milk chocolate, pink chocolate, blond chocolate and vegetable fats are a material having (substantially) the same fusion profile as said dark chocolate, said white chocolate, said milk chocolate, said pink chocolate or said blond chocolate alone, and/or is crystallized in the same form.
